(19) United States
(12) Patent Application Publication
(10) Pub. No.: US 2012/0046873 A1
(43) Pub. Date: Feb. 23, 2012

(54) HAIRSCAN FOR GROWTH ANALYSIS

(76) Inventor: Michael I. Rabin, Gates Mills, OH (US)

(21) Appl. No.: 13/213,465

(22) Filed: Aug. 19, 2011

Related U.S. Application Data
(60) Provisional application No. 61/375,162, filed on Aug. 19, 2010.

(51) Int. Cl. G06F 19/00

(52) U.S. Cl. 702/19

(57) ABSTRACT

Effectiveness of a therapeutic regimen applied to hair follicles is determined by establishing a baseline cross-sectional dimension of a first cross-sectional portion of a hair shaft that is acquired from a target area of a patient. A post-therapeutic cross-sectional dimension of a second cross-sectional portion of a hair shaft that is acquired from the target area of a patient subsequent in time to the acquisition of the first cross-sectional portion of a hair shaft and to an application of a therapeutic agent to a hair follicle that generated the second cross-sectional hair shaft portion, is also determined. Thus, a difference between the baseline and post-therapeutic cross-sectional dimensions is determined and used to automatically revise a therapeutic regimen frequency, duration, or duty cycle for an application of the therapeutic agent applied to the hair follicle that generated the post-therapeutic hair shaft portion.

### RELATED APPLICATION

This application claims the benefits of the following provisional patent application previously filed in the United States Patent and Trademark Office by common inventor Michael I. Rabin entitled “HAIRSCAN FOR GROWTH ANALYSIS,” filed Aug. 19, 2010, Ser. No. 61/375,162, Confirmation No. 8283.

### BACKGROUND

The present invention relates to the analysis of hair shaft growth and, in one aspect, to the field of hair growth and regeneration in a human scalp in view of accurately determining and distinguishing the effects of therapeutic agents on said growth.

### BRIEF SUMMARY

Embodiments of the present invention include methods, articles of manufacture with computer readable storage mediums having computer readable program code embodied therewith, and systems, each for determining effectiveness of a therapeutic regimen applied to hair follicles by establishing a baseline cross-sectional dimension of a first cross-sectional portion of a hair shaft that is acquired from a target area of a patient. A post-therapeutic cross-sectional dimension of a second cross-sectional portion of a hair shaft that is acquired from the target area of a patient subsequent in time to the acquisition of the first cross-sectional portion of a hair shaft and to an application of a therapeutic agent to a hair follicle that generated the second cross-sectional hair shaft portion is determined. Thus, the difference between the baseline and post-therapeutic cross-sectional dimensions is determined and used to automatically revise a therapeutic regimen frequency, duration, or duty cycle for an application of the therapeutic agent applied to the hair follicle that generated the post-therapeutic hair shaft portion.

Some systems also include a rotating screw device to which one end of a sample strand of hair is attached; a weight that is attached to an opposite end of the sample hair strand and holds the hair strand straight and fixed transverse to its length by gravity when disposed below the rotating screw device; and a laser width measuring device that moves upward and downward along the length of the hair strand as the rotating screw device rotates the hair strand and thereby acquires a plurality of cross-sectional dimensions of the sample hair strand along its length.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a block diagram illustration of an embodiment of a method or system for hair analysis according to the present invention.

FIG. 2 is a graphical illustration of discrete cross-section diameters acquired along the length of a hair according to embodiments of the present invention.

FIG. 3 is a graphical illustration of a hair cross-sectional profile data according to embodiments of the present invention.

FIG. 4 is a graphical illustration of discrete cross-section diameters acquired along the length of a hair according to embodiments of the present invention.

FIG. 5 is a graphical illustration of a hair cross-sectional profile data according to embodiments of the present invention.

FIG. 6 is a block diagram illustration of an embodiment of an apparatus according to the present invention for measuring the shape or dimensions of a hair shaft along its length.

FIG. 7 is a graphical illustration of a hair cross-sectional profile data according to embodiments of the present invention.

FIG. 8 is a graphical illustration of a hair cross-sectional profile data according to embodiments of the present invention.

FIG. 9 is a graphical illustration of a hair cross-sectional profile data according to embodiments of the present invention.

FIG. 10 is a graphical illustration of a hair cross-sectional profile data according to embodiments of the present invention.

FIG. 11 is a block diagram of a computerized implementation of an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is desired to alter the visual appearance of human hair shafts by increasing their visibility or other appearance attributes, thereby providing a thicker and more lustrous visible appearance in combination with other hair shafts. It is known to apply therapeutic agents to hair follicles in order to change their behavior with respect to the generation of hair shafts, with the goal of increasing their perceived thickness and lustrous visible appearance of the hair shafts. However, therapeutic agents may increase or decrease the rate of growth, thickness and/or shape of the generated hair shafts. For example, one agent may encourage a faster growth rate but at a cost of reducing the thickness of the generated hair shaft, which although increasing the rate of hair shaft growth may result in a less desirable thinner hair shaft that is less visible than one prior to application of the agent.

Prior art measures of efficacy of therapeutic agents on hair follicles generally fail to provide adequate determinations of effects on rate of growth, luster, hair thickness and other factors that may cumulatively determine a desirable, undesirable or essentially ineffective outcome. For example, analysis and comparison of before and after photographs of human scalps may be very difficult to control for hair length and style, etc., which may result in inconclusive or even wrong conclusions with respect to efficacy of an applied agent. Photomicrographs of individual hair shafts may be difficult to interpret, and moreover they provide data with respect to only singular cross-sections or other small samples of an entire hair shaft for evaluation. Arbitrary visual separation of hairs into terminal and non-terminal hairs by a human analyst may also introduce variable, personal degrees of judgment and bias that affect data acquisition with regard to observed skin coverage and visible occlusion by hair shaft thickness and growth rate.

The overall thickness profile normal hair shaft may be described as a generally elliptical cross-sectional shape when viewed over the length of an entire strand, with a pointed end of the hair shaft at its initial tip, the hair shaft then thickening to a maximal thickness at a point generally near the tip, and then diminishing gradually along the length of the hair shaft towards its base with respect to this maximal thickness. See Hutchinson P E, Thompson J R, “The cross-sectional size and shape of human terminal scalp hair,” Br. J. Dermatol, 1997 February; 136(2):159-65; also Nizzimov, J., “Normal head-hair length is correlated with its diameter,” Clin. Exp. Derm., 2004, 29, 649-657. Accordingly, measurement of hair shaft diameter is generally problematic. In one aspect, it may be difficult to determine if a long axis or short axis is being measured with respect to a given hair shaft or section of a hair shaft. Measuring bundles of hairs rather than individual hairs may produce a composite value or index; however, such an approach is of limited value in determining efficacy upon individual hair shafts.

Embodiments of the present invention provide for systems that analyze or otherwise measure attributes of individual hair at discrete points or along the entire length of the hair shaft, for example from a shaft tip to a base. Efficacy of therapeutic agents on hair follicles may be automatically determined as a function of assessing changes in shaft diameter or cross sectional area parameters over time, for example as represented by a length of the hair shaft, and in some embodiments as a function of comparison to expected or known baseline profiles of the shafts of untreated hair follicles or previously treated hair follicles.

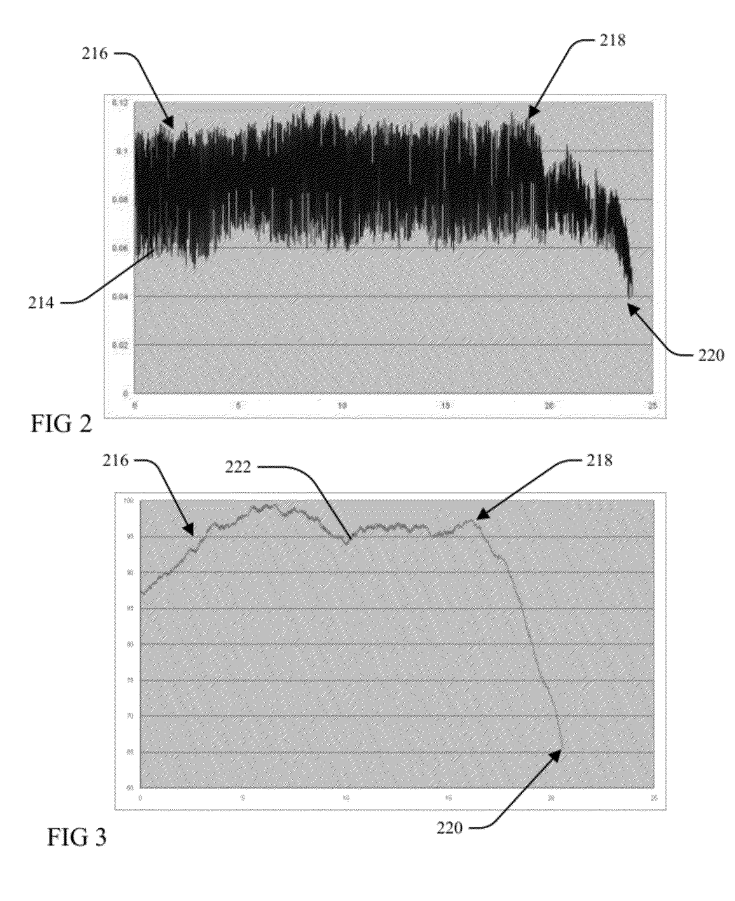

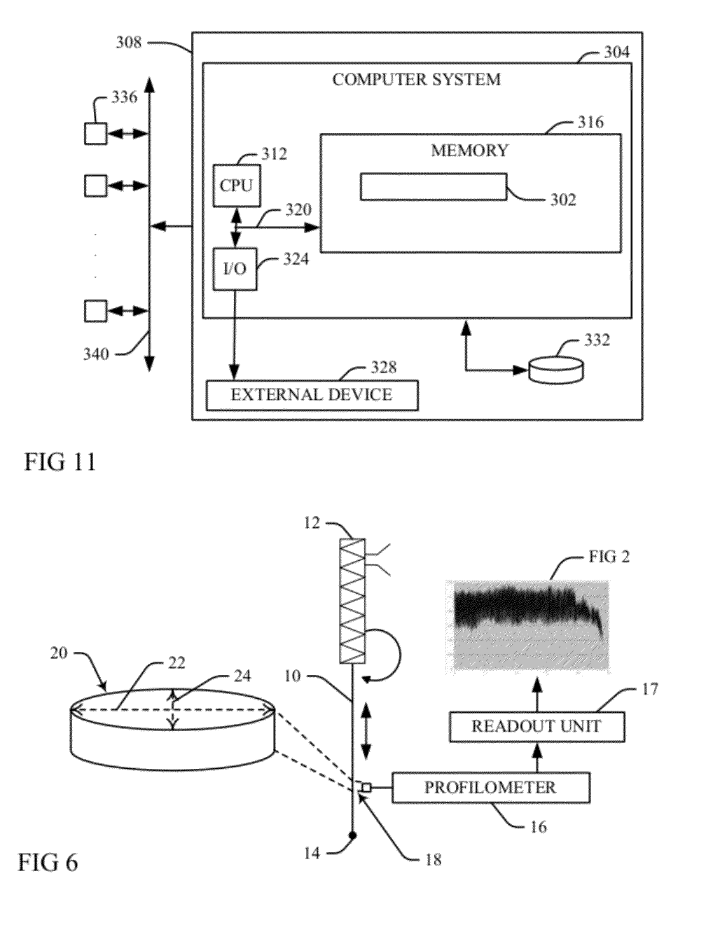

One embodiment of an apparatus according to the present invention for measuring the shape or dimensions of a hair shaft along its length is shown in FIG. 6. One end of a sample strand of hair 10 is attached to a rotating screw device 12 while the other end hangs by gravity by means of a miniature weight 14 that holds the hair strand straight and fixed transverse to its length. A laser width measuring device or other shape profilometer means 16 is positioned to measure the instantaneous hair shaft width transverse to a measuring beam 18. As the screw turns under motorized control, the hair advances up or down so as to expose cross-sectional selections 20 of the width of the hair as a function of length. An elliptical hair shaft will have an oscillating thickness (diameter) signature or profile, corresponding to long 22 and short 24 axes of the cross-section selection ellipse 20 and the overall envelope of the profile in time may provide a measurement of ellipticity as a function of length along the hair shaft, which is easily calibrated relative to the point where the shaft was detached from the subject's head. The long and short axes, widths or “diameters” can be used to calculate an average diameter as one example of a cross-sectional profile parameter. Another cross-sectional profile parameter is the cross-sectional area which is easily derived from the long and short diameters. Accordingly, a Readout Unit 17 in communication with the Profilometer 16 may provide the graphical illustration of FIG. 2, which graphically illustrates a series of discrete diameters determined by the Profilometer 16 over a length of the hair shaft 10, as described with more particularity supra in the specification.

Efficacy of any given hair treatment may be determined by observing divergences from normal, baseline growth rate and thicknesses. Embodiments of the present invention may analyze hair growth and hair treatment efficacy as a function of recognizing that hair shaft long-axis diameter generally slowly decreases over time while short-axis diameter generally remains flat, and thus over the length of a growing hair shaft, particularly in the absence of pattern hair loss. Accordingly, one effective treatment modality may be expected to reverse this gradually-thinning slope from the maximal thickness point near the tip, instead increasing long and or short axis hair shaft diameter and thus cross-sectional area as one travels along the hair shaft toward its base, which would generally produce an increase in perceived fullness, particularly when taken in consideration with other hairs and in a composite view of a human scalp or other portion of skin containing multiple hairs.

In one aspect increasing the short axis diameter by a greater amount than an increase in the long axis diameter will cause an elliptical cross-section to become progressively rounder as the differences between the long and short axis dimensions decrease. Such shape rounding may improve the perceived luster or thickness of the hair shaft, and accordingly some embodiments of the present invention may adjust therapeutic agent applications to cause an increased roundness in the cross-sectional profile of the generated hair shafts.

Embodiment of the present invention may analyze hair shaft segments growing before and after initiating application of a therapeutic agent to determine treatment effect in view of observing both growth rate and perceived thickness or luster of the shafts of the respective hair follicles. Thus, a system according to the present invention may automatically adjust the amount, rate or other parameter of application of a therapeutic agent applied to a hair follicle in order to control the rate of growth, cross-sectional shape and/or thickness of a resultant generated hair shaft, in one aspect to avoid stimulating faster growth rates that may result in corresponding diminishments in thickness, but instead to ensure that any increase in growth rate does not diminish the perceived thickness profiles of the shafts generated by hair follicles receiving therapeutic agent treatments. Thus, patient response may be monitored and associated and therapeutic agent consumables and treatment protocols changed as needed automatically in response to hair shaft analysis. Shed hair, which is also called Telogen hair, may also be used to assess baseline hair growth patterns and response to treatments and may be considered superior for analysis since it may represent the entire life cycle of the hair if the Anagen tip of the hair is identified as well (i.e., it was never trimmed during a haircut, and thus the entire hair, from “birth” until “death” is measured).

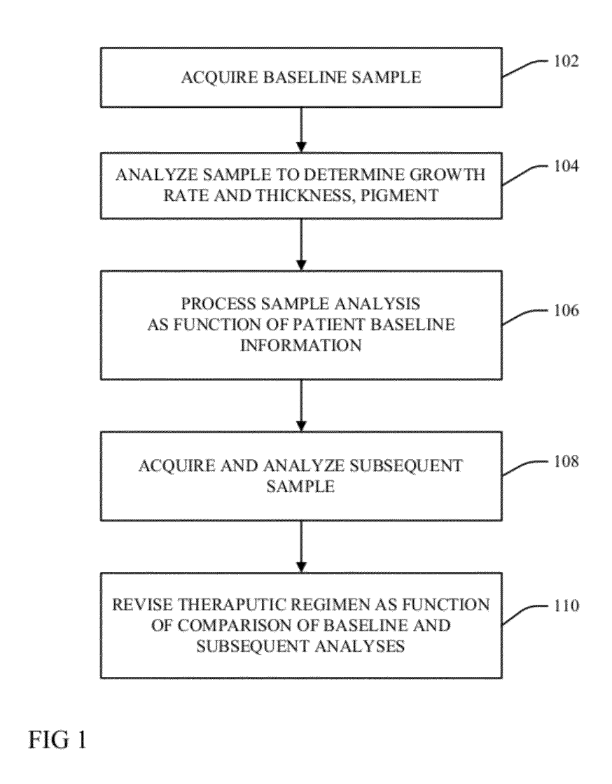

FIG. 1 illustrates a hair analysis system according to the present invention. At 102 a sample hair shaft is acquired from a target area relevant to treatment by therapeutic agent to serve as a baseline sample, the sample analyzed at 104 to obtain shaft diameter measurements over a length of the shaft, and, in some embodiments, to also determine a hair pigmentation level, and the sample analysis data processed at 106 with respect to baseline patient information (for example, patient identity, date of acquisition, history of patient with respect to therapeutic agent usage, etc.).

At 108 another hair shaft sample is acquired subsequent to a period of treatment by the therapeutic agent and analyzed as a function of a comparison with the base sample analysis at 104. More particularly, a cross-sectional dimension of the hair is computed, and optionally color changes noted, along a length of the hair shaft representing a time, the length at least representing a time from acquisition of the baseline sample through acquisition of the subsequent sample, and any changes in growth rate, hair thickness, and hair pigmentation are noted in associated with the therapeutic agent treatment applied during said time period as possible responses to the applied treatment. At 110 the therapeutic regimen applied during the intervening time between the acquisition of the first and second samples is recognized or determined and automatically revised (if necessary or indicated) as a function of the observed changes in growth rate, hair thickness, and/or hair pigmentation, for example changing a frequency, duration, duty cycle, etc., of application of the therapeutic agent by one or more systems.

One embodiment of the present invention analyzes sample hair shafts through use of a hairscan device which holds a hair sample vertically and, while rotating it in a downward or upward spiral, makes diameter measurements through use of a laser micrometer, for example as illustrated in FIG. 6, and wherein a camera may optionally take images to assess hair pigmentation level. Thus, FIG. 2 graphically illustrates a series of diameters 214 of a baseline sample hair acquired by a Profilometer 16 (FIG. 6) according to the present invention and represented in millimeters (also herein sometimes cited in microns equivalents) along a vertical or y-axis at various points along a length of a hair shaft, which is represented in centimeters along the horizontal or x-axis. It is noted that hair shafts generally have an elliptical cross-sectional shape at any given point, and accordingly the spiral diameter measurements 214 comprise a series of greater and lesser diameter measurements in a sequential series. The shape of the hair shaft along the length also evidences gradually changing diameter 214 values, wherein the anagen tip of the hair generated at the birth of the hair is located at about the 24 cm point on the horizontal/x-axis and has a pointed end with a smallest cross-sectional diameter 220, a middle body region near the end of the tip has larger diameters the largest long-axis diameter 218 (and thus resulting in a cross-sectional shape with a larger ellipticity), and wherein this expansion generally contracts to provide relatively lesser long-axis diameters as one travels towards the base area 216.

FIG. 7 provides another graphical illustration of a series of diameters 214 of another sample hair acquired by the Profilometer 16 (FIG. 6) represented in microns along a vertical y-axis at various points along an entire length of a hair shaft from its anagen tip at 21 centimeters on the horizontal x-axis to its ending telogen bulb at zero centimeters, which represents the end of growth of the hair shaft. Moving average values are also plotted: a major/large axis diameter moving average 704 for the large axis diameters 22 (FIG. 6), a minor/small axis diameter moving average 706 for the small axis diameters 24 (FIG. 6), and a cross-sectional area moving average 708. The moving averages may represent an average of a current value and the values over surrounding, preceding and/or subsequent length sections, for example covering a 3 cm section of the shaft length, though other values may be practiced. It is noted that maximum large axis diameters 22 of about 100 microns occur at about the 14 cm. point of the growing hair, and that these then begin to slowly taper off as one progresses toward the telogen bulb end, decreasing to about 72 microns at a point roughly 2 millimeters from the telogen bulb end. It also noted that the short axis 24 measurements are generally flat from about the 19 cm point until shortly before the telogen bulb end. Thus, in one aspect embodiments of the present invention may map changing cross-sectional shapes over the length of the hair, with the minor and major axes 22 and 24 presenting generally elliptical cross-section profiles 702 in middle regions of the hair (for example, from about the 19 cm point to about the 5 cm point), and wherein the cross-section profiles 702 presented in the beginning section (from tip to about 19 cm.) and the terminal section (from about the 5 cm. point to near the telogen bulb end) of the hair are more circular. Thus, in one aspect, examples and embodiments of the present invention demonstrate that as hair shafts lengthen over time they inevitably and eventually thin towards their base, and differences between the minor and major axes are reduced before they age out or otherwise fall off of the host human (or other hair-bearing organism).

In one embodiment, analysis of the raw data diameters 214 of FIG. 2 according to the present invention generates the representational cross-sectional profile data 222 of FIG. 3. The cross-sectional profile data 222 is derived as a function of differentially weighting of each of the raw data 214 minor and major diameters, and wherein the profile 222 may be better utilized in analysis of the hair over the raw data 214. Thus, the profile 222 more clearly illustrates how an overall, composite cross-sectional thickness value of the baseline sample shaft is thin at the tip area 220, thickens near the tip and then over a predominant portion of the length 222, and then starts to taper towards the base area of the hair 216.

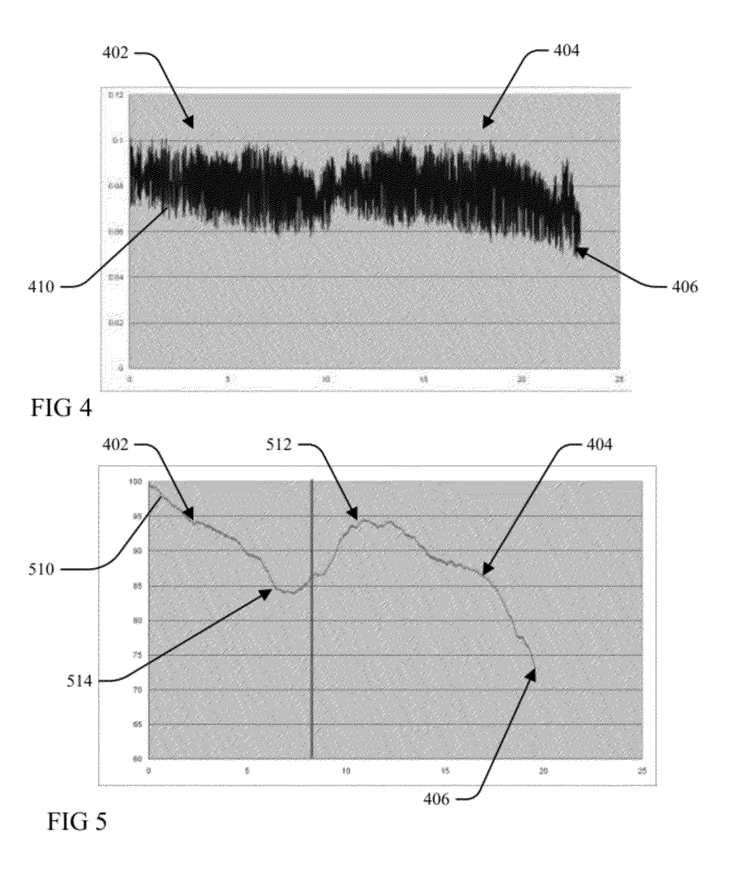

FIG. 4 graphically illustrates a series of diameters 410 of a second, subsequent sample hair taken after application of a therapeutic agent during an intervening time period. In comparison to FIG. 2, the totality of the raw data diameters 410 present a different composite look relative to the sample hair raw data diameters 214, though comparison of said raw data 214-410 yields no direct indication as to the effect of the therapeutic agent over the time period or as to who to vary or alter that application in view of the comparison.

However, FIG. 5 illustrates a representational cross-sectional profile 512 derived from the diameters 410 of FIG. 4 according to the present invention, again derived as a function of differentially weighting of each of the raw data 410 minor and major diameters. Review of the profile 512 in view of the baseline sample profile 222 quickly indicates the effect of the therapeutic agent applied during the intervening interval. In one example, the profile 512 shows that the diameters 410 thickened from the tip area 406 through the middle area 404 and reached a maximal thickness at a region 512 about 3 cm from the tip, and after 45 days of elapsed growth time from the tip 406. This is followed by a rapid growth rate and corresponding rapid drop in thickness diameters over the next 2 centimeters/one month to a low diameter region 514, the shaft growth then stabilizing and rebounding with respect to increasing thickness and slowing growth rate toward the base 402 over the next time period.

Thus, embodiments of the present invention may reduce the amount of therapeutic agent applied over the shoulder region 402-through-512 of the profile 510 for current or future therapy, as it is readily determined that application of the therapeutic agent between the sample and the current acquisition has increased the hair growth rate to rapid, resulting in a corresponding thinning of the growing hair shaft. Conversely, in some applications where rapid yet thin hair growth is desired, a therapeutic protocol may be left unaltered, or application of therapeutic agents increased to encourage even faster growth.

The profiles 222 and 510 generated by the present invention thus provide improved illustration of the gross behavior of hair follicles as a function of application of therapeutic agents, or as control groups, one more readily accessible and useful in hair shaft analysis with respect to the efficacy of therapeutic agent applications in contrast with raw data acquired through prior art methods. One can more readily determine or detect changes in thickness over the overall length of a hair sample, and thus readily determine whether the effects in both short-term and long-term time periods of therapeutic agent applications, as well as changes in protocols of those applications.

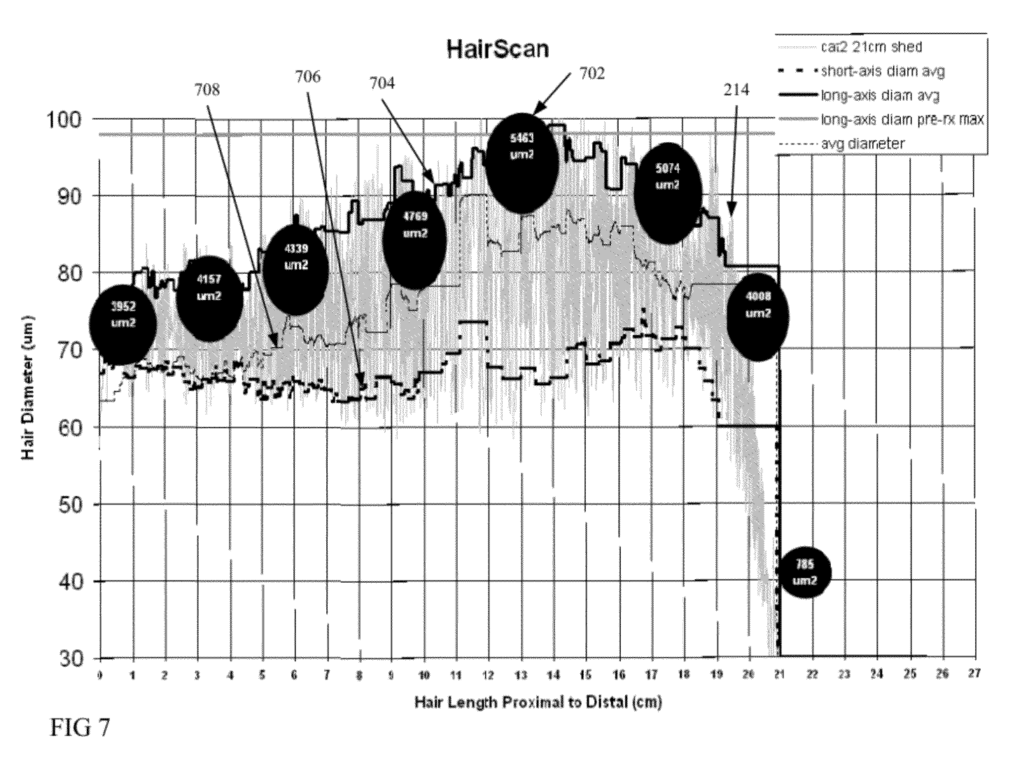

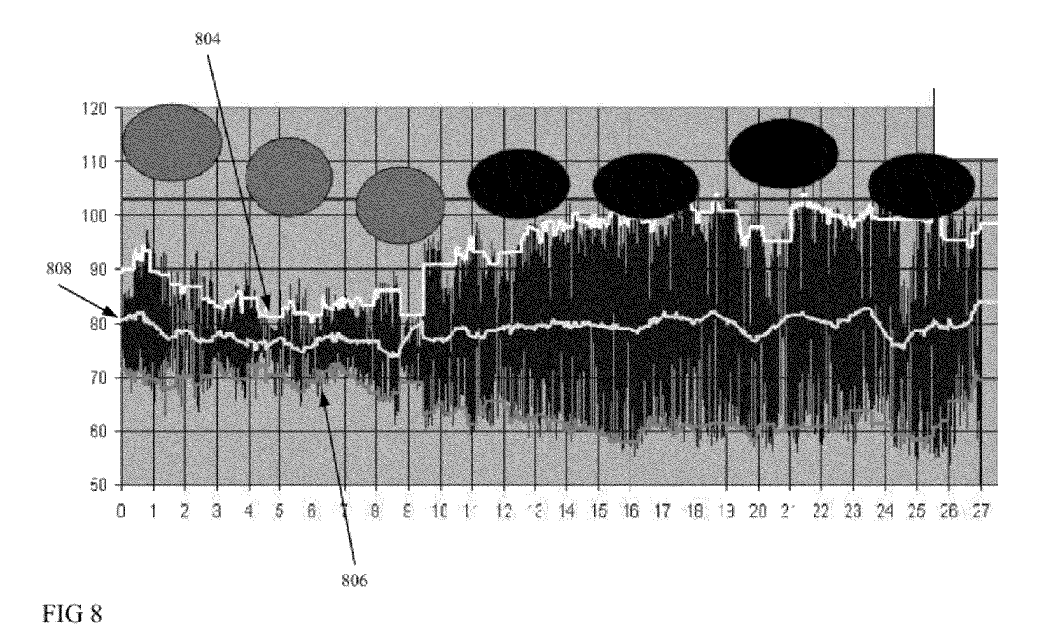

FIG. 8 provides a graphical illustration of a series of diameters 214 of another hair acquired by the Profilometer 16 (FIG. 6) represented in microns along a vertical y-axis at various points along a length of the hair shaft from a cut tip at 27 cm. to another cut end at zero cm., wherein the hair is acquired is cut from a donor who provided the base-line sample hair of FIG. 7 (the shaft having no anagen tip or telogen bulb end) after an elapsed time period wherein a therapeutic agent was applied to the cut hair sample. Comparison of the cross-section of diameters 214 and associated major/large axis diameter moving average 804, minor/small axis diameter moving average 806 and cross-sectional area moving average 808 data to the same respective data elements 214, 704, 706 and 708 of FIG. 7 reveals an abrupt change in both long axis and short axis values at the 9 cm. point in FIG. 8, and then a trend of increasing shape rounding and overall cross-sectional area moving average values 808 moving from the 9 cm. point toward the cut end at the zero cm. point, relative to the base sample hair of FIG. 7.

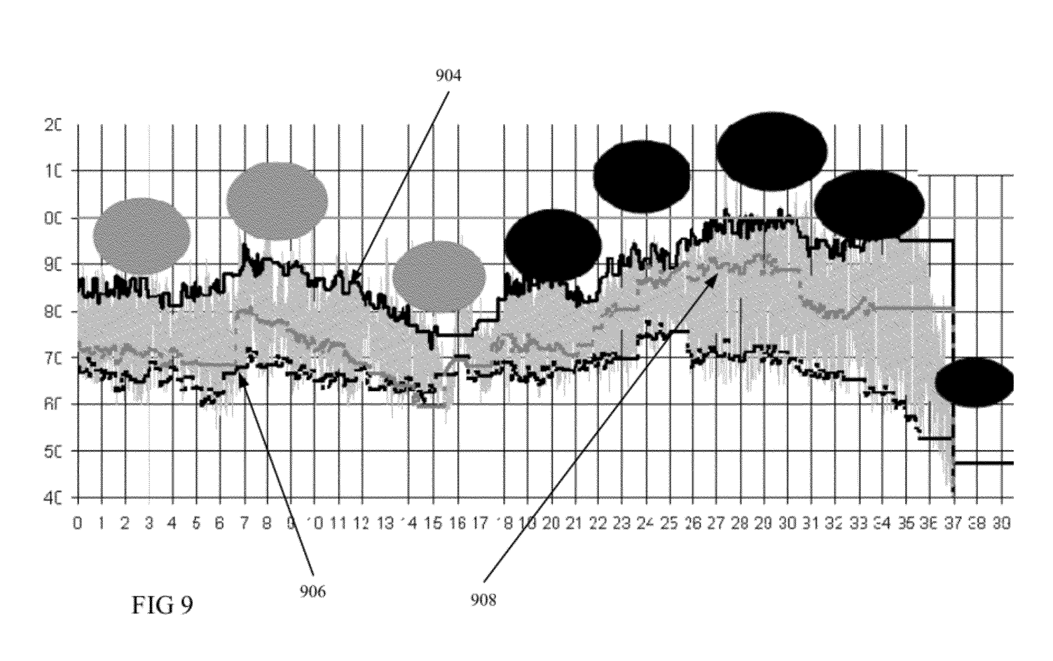

FIG. 9 provides another graphical illustration of a series of diameters 214 of another hair acquired by the Profilometer 16 (FIG. 6) represented in microns along a vertical y-axis at various points along a length of the hair shaft from an anagen tip at 37 cm. to another cut end at zero cm (no telogen bulb end). Comparison of the cross-section of diameters 214 and associated major/large axis diameter moving average 904, minor/small axis diameter moving average 906 and cross-sectional area moving average 908 data to the same respective data elements 214, 704, 706 and 708 of FIG. 7 reveals an abrupt change in the long axis diameter at the 14 cm. point in FIG. 9, and then a trend of increasing overall cross-sectional area moving average values 908 moving from the 14 cm. point toward the cut end at the zero cm. point, relative to the base sample hair of FIG. 7.

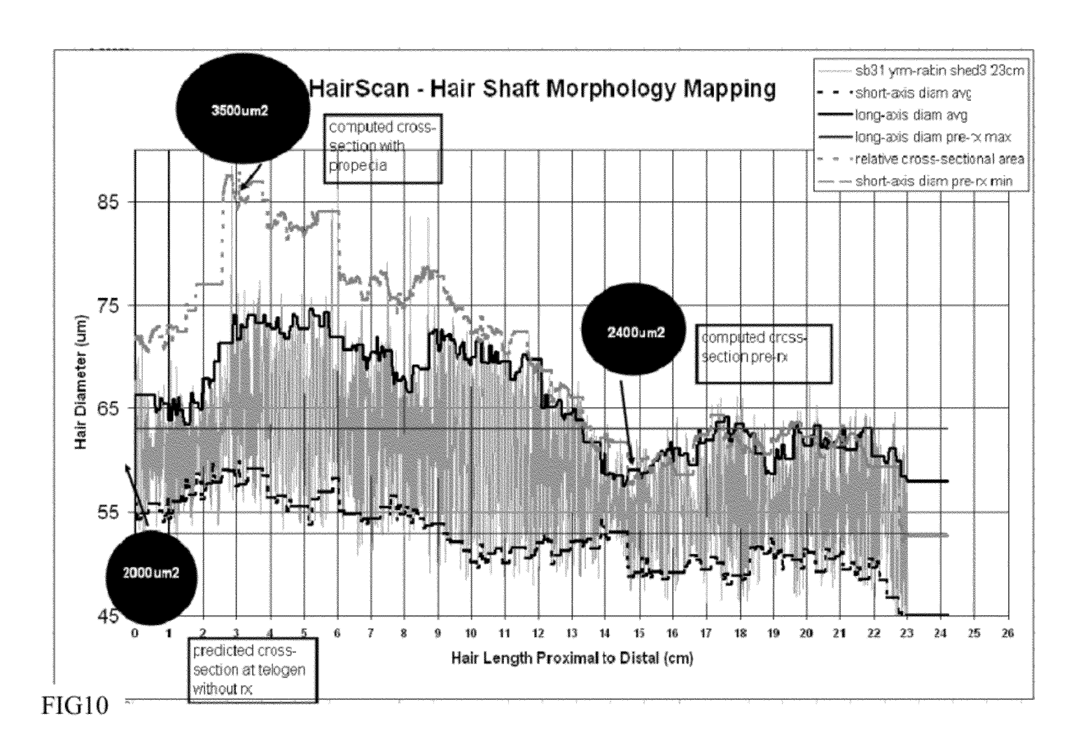

FIG. 10 provides another graphical illustration of a series of diameters 214 of another hair acquired by the Profilometer 16 (FIG. 6) represented in microns along a vertical y-axis at various points along a length of the hair shaft from cut end at 23 cm to another cut end at zero cm (no telogen bulb end). In another aspect of the present invention, efficacy of a therapeutic agent may be determined by observing how the actual cross-sectional dimensions of a hair change after application of the therapeutic agent from typical or predicted cross-sectional dimensions for that hair if left un-treated. More particularly, the graph in FIG. 10 reflects that the cross-sectional area for the hair strand as one approaches the telogen bulb end is expected to be about 2000 microns-squared, as projected from the measurement data acquired over the length from 23 cm to 15 cm. However, the actual cross-sectional dimension at the 3 cm is 3500 microns-squared, which may be imputed to the effects of a therapeutic agent applied to the hair during the growing period occurring after the 15 cm point.

Embodiments of the present invention may thus observe and compare one or more of a wide variety of hair sample attributes to determine the efficacy of applied therapeutic agents. Hair samples used for baseline values may be different from those used to acquire comparison values after application of therapeutic agents, or they may be different samples taken along the same hair at different times. Attributes suitable for comparison include relative differences in either or both minor and major axes of generally elliptical cross-sections of the respective hair portions, or moving averages thereof. Cross-sectional dimensions may also be averages of differentially weighted values of the minor and major axes of the respective cross-sections.

Some embodiments of the present invention automatically revise an application of a laser light as a therapeutic agent by one or more systems. For example, embodiments of the present invention may automatically upload profile analysis to a programmable laser light application system to revise a laser treatment protocol (frequency, duration, duty cycle, etc.), such as by automatically changing a program in a programmable laser application device. One example of a lasercap is taught by a PCT patent application by the present inventor entitled “PHOTOTHERAPY LIGHT CAP” by RABIN, Michael (US) and SMITH, David, A. (US), Pub. No. WO/2008/144157, International Application No. PCT/US2008/061350; Publication Date: 27 Nov. 2008; International Filing Date: 23 Dec. 2008. In some embodiments, information from the microprocessor of such lasercaps regarding individual treatment dates, times, etc. may be automatically uploaded to the analysis device of FIG. 1 to take individual patient compliance into account in performing the hair follicle analysis and automated therapeutic regimen or protocol revisions described herein. Patient hair is sampled (for example, using hair-hook devices) to gather known quantities of hair from target areas at specified time intervals; for example, 30 days pre-treatment, day of first treatment, and then periodically during treatment (e.g., 30, 60, 90 days, etc.). The sampled hair is analyzed with associated patient data (identity, date, history, etc.) and cross-sectional diameters and/or areas of the hair sample are computed all along the hair shaft and color changes also noted all along the hair shaft in order to assess growth rate, hair thickness, and hair pigmentation changes in response to treatment, the noted changes used to automatically change the individual patient lasercap treatment protocol (frequency, duration, duty cycle, etc.) by changing the program in the microprocessor of the lasercap.

Other therapeutic agent application systems may apply pharmaceuticals and topical agents such as Rogaine™ (Minoxidil™) and Propecia™ (Finasteride™), and thus the present invention may be used to automatically change the rates and amounts of applications of said pharmaceuticals by automated devices (for example, a personal device worn under a hat and programmable to administer a pharmaceutical during certain times and in certain amounts may be reprogrammed to change the rate or amount of application as a function of analysis performed by the present invention.)

It will be noted that in some embodiments of the present invention human oversight and auditing of the process and automated protocol revisions may be beneficial, for example, through physician monitoring of patients in order to determine optimal dosing through reflecting human analysis and discretion inputs in the process. Physicians and other human auditors may fine tune protocol revisions as a function of personal knowledge and experience in dealing with hair density, skin color, shedding histories, preferential hair growth rates, etc.

In another aspect, automated hair analysis according to the present invention may be used to determine early response (or lack thereof) to an initial round of therapeutic treatments and to make adjustments gradually (e.g., start at a lower dose and, if no response, then maybe increase dose; or, growth rate takes off without improved cross-sectional area, then maybe reduce).

Thresholds and other specified values for hair growth rate or hair thickness values may be predetermined or specified by the user. They may also be learned through comparison to historical values, including personal histories that may provide particular individualized growth rate and hair shaft thickness values for use with the present invention.

Some embodiments may use or apply visible markers to hair shafts to determine actual growth rates or pigment changes. For example, thin bleach marks may be applied to hair hairs at a known distance from the scalp to readily indicate the amount of hair shaft length that has grown between applications of reference marks.

Referring now to FIG. 11, an exemplary computerized implementation of an embodiment of the present invention includes computer or other programmable device 308 in communication with hair sampling devices 336 (for example, a video camera or video server, laser micrometer, etc.) that analyzes data for determination of hair shaft growth rate and thickness profile values according to the present invention, for example in response to computer readable code 302 in a file residing in a memory 316 or a storage system 332 through a computer network infrastructure 308. The implementation is intended to demonstrate, among other things, that the present invention could be implemented within a network environment (e.g., the Internet, a wide area network (WAN), a local area network (LAN) or a virtual private network (VPN), etc.) Communication throughout the network 320/340 can occur via any combination of various types of communications links; for example, communication links can comprise addressable connections that may utilize any combination of wired and/or wireless transmission methods.

Where communications occur via the Internet, connectivity could be provided by conventional TCP/IP sockets-based protocol, and an Internet service provider could be used to establish connectivity to the Internet. Still yet, the network infrastructure 308 is intended to demonstrate that an application of an embodiment of the invention can be deployed, managed, serviced, etc. by a service provider who offers to implement, deploy, and/or perform the functions of the present invention for others.

The infrastructure 308 comprises various components, some of which are illustrated within the computer 304. More particularly, as shown, the computer 304 includes a processing unit (CPU) 312 in communication with one or more external I/O devices/resources 328 (for example, automated therapeutic agent applications systems 328 such as laser Devices, pharmaceutical and topical agent application devices, etc.) and storage systems 332. In general, the processing unit 312 may execute computer program code, such as the code to implement one or more of the process steps illustrated in FIG. 1, which is stored in the memory 316 and/or the storage system 332.

The network infrastructure 308 is only illustrative of various types of computer infrastructures for implementing the invention. For example, in one embodiment, computer infrastructure 308 comprises two or more computing devices (e.g., a server cluster) that communicate over a network. Moreover, the computer 304 is only representative of various possible computer systems that can include numerous combinations of hardware. To this extent, in other embodiments, the computer 304 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations. Further, I/O interfaces 320/340 can comprise any system for exchanging information with one or more of an external server and or client (not shown). Still further, it is understood that one or more additional components (e.g., system software, math co-processing unit, etc.), not shown, can be included in the computer 304 or server or client.

One embodiment performs process steps of the invention on a subscription, advertising, and/or fee basis. That is, a service provider could offer to provide automated determination of hair shaft growth rate and thickness profile values. In this case, the service provider can create, maintain, and support, etc., a computer infrastructure, such as the network computer infrastructure 308 that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for executing one or more of the processes, systems and articles for determination of hair shaft growth rate and thickness profile values described above. In this case, a computer infrastructure, such as the computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as the computers/devices 308/328, from a computer-readable medium; (2) adding one or more computing devices to the computer infrastructure; and (3) incorporating and/or modifying one or more existing systems of the computer infrastructure to enable the computer infrastructure to perform the process steps of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

Certain examples and elements described in the present specification, including in the claims and as illustrated in the Figures, may be distinguished or otherwise identified from others by unique adjectives (e.g., a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for determination of hair shaft growth rate and thickness profile values, the method comprising:
acquiring a sample hair shaft from a target area relevant to treatment by a therapeutic agent to serve as a baseline sample;
analyzing the sample via a processing unit to obtain shaft diameter measurements over a length of the shaft with respect to baseline patient information;
acquiring another hair shaft sample subsequent to a period of treatment by the therapeutic agent;
analyzing the subsequent sample via the processing unit as a function of a comparison with the base sample analysis, the analyzing the subsequent sample comprising computing and comparing cross-sectional area values of the samples and determining any changes in growth rate and hair thickness;
determining a therapeutic regimen with respect to the therapeutic agent during an intervening time between acquisitions of the samples;
automatically revising via the processing unit the determined therapeutic regimen if an observed change in a growth rate or hair thickness value indicates revision is necessary.

2. A method for determining effectiveness of a therapeutic regimen, the method comprising:
establishing via a processing unit a baseline cross-sectional dimension of a first cross-sectional portion of a hair shaft that is acquired from a target area of a patient;
determining via the processing unit a post-therapeutic cross-sectional dimension of a second cross-sectional portion of a hair shaft that is acquired from the target area of a patient subsequent in time to the acquisition of the first cross-sectional portion of a hair shaft and to an application of a therapeutic agent to a hair follicle that generated the second cross-sectional hair shaft portion;
determining via the processing unit a difference between the baseline cross-sectional dimension and the post-therapeutic cross-sectional dimension; and
automatically revising via the processing unit a therapeutic regimen frequency, duration, or duty cycle for an application of the therapeutic agent that was applied to the hair follicle that generated the post-therapeutic cross-sectional dimension hair shaft portion as a function of the determined difference between the baseline cross-sectional dimension and the post-therapeutic cross-sectional dimension.

3. The method of claim 2, further comprising:
establishing a baseline hair pigmentation color for the baseline cross-sectional hair shaft portion;
determining a difference between the baseline hair pigmentation color and a pigmentation color of the post-therapeutic cross-sectional hair shaft portion; and
automatically revising the therapeutic regimen frequency, duration, or duty cycle for the application of the therapeutic agent that was applied to the post-therapeutic cross-sectional dimension hair shaft portion as a function of the determined difference between the pigmentation colors of the baseline cross-sectional hair shaft portion and the post-therapeutic cross-sectional hair shaft portion.

4. The method of claim 2, wherein the baseline and post-therapeutic cross-sectional dimensions comprise at least one of minor and major axes of generally elliptical cross-sections of the respective hair portions.

5. The method of claim 4, wherein the baseline and post-therapeutic cross-sectional dimensions comprise moving averages of the at least one minor and major axes of the generally elliptical cross-sections of the respective hair portions.

6. The method of claim 4, wherein the baseline and post-therapeutic cross-sectional dimensions are percentages of difference between the minor and major axes of the respective cross-sections.

7. The method of claim 4, wherein the baseline and post-therapeutic cross-sectional dimensions are averages of differentially weighted values of the minor and major axes of the respective cross-sections.

8. The method of claim 2, wherein the baseline and post-therapeutic cross-sectional dimensions are cross-sectional areas of the respective hair portions.

9. The method of claim 2, further comprising:
automatically revising via the processing unit the therapeutic regimen frequency, duration, or duty cycle for an application of the therapeutic agent that was applied to the hair follicle that generated the post-therapeutic cross-sectional dimension hair shaft portion as a function of a determined difference between the post-therapeutic cross-sectional dimension and a predicted cross-sectional dimension that is projected from the baseline cross-sectional dimension.

10. The method of claim 2, further comprising:
determining the baseline and post-therapeutic cross-sectional dimensions through using a laser micrometer making cross-sectional diameter measurements of a hair shaft while moving upward or downward relative to a length of the hair shaft while the hair shaft is rotated.

11. A system, comprising:
a rotating screw device to which one end of a sample strand of hair is attached;
a weight that is attached to an opposite end of the sample hair strand and holds the hair strand straight and fixed transverse to its length by gravity when disposed below the rotating screw device; and
a laser width measuring device that moves upward and downward along the length of the hair strand as the rotating screw device rotates the hair strand and thereby acquires a plurality of cross-sectional dimensions of the sample hair strand along its length.

12. The system of claim 11, wherein the hair strand shaft is generally elliptical, and wherein the laser width measuring device acquires an alternating plurality of major and minor cross-sectional diameters of cross-sectional dimensions of the sample hair strand.

13. The system of claim 12, further comprising:
a readout unit in communication with the laser width measuring device that provides a graphical illustration of the acquired cross-sectional dimensions of the sample hair strand.

14. The system of claim 13, further comprising:
a processing unit;
a computer readable memory; and a computer-readable storage medium;
wherein the processing unit, when executing program instructions stored on the computer-readable storage medium via the computer readable memory:
establishes a baseline cross-sectional dimension from a cross-sectional dimension acquired from a first cross-sectional portion of the sample hair strand;
determines a post-therapeutic cross-sectional dimension from a cross-sectional dimension acquired from a second cross-sectional portion of the sample hair strand that is acquired from the target area of a patient subsequent in time to the acquisition of the first cross-sectional portion and to an application of a therapeutic agent to a hair follicle that generated the second cross-sectional hair strand portion;
determines a difference between the baseline cross-sectional dimension and the post-therapeutic cross-sectional dimension; and
automatically revises a therapeutic regimen frequency, duration, or duty cycle for an application of the therapeutic agent that was applied to the hair follicle that generated the post-therapeutic cross-sectional dimension hair strand portion as a function of the determined difference between the baseline cross-sectional dimension and the post-therapeutic cross-sectional dimension.

15. An article of manufacture, comprising:
a computer readable storage medium having computer readable program code embodied therewith, the computer readable program code comprising instructions that, when executed by a computer processor, cause the computer processor to:
establish a baseline cross-sectional dimension of a first cross-sectional portion of a hair shaft that is acquired from a target area of a patient;
determine a post-therapeutic cross-sectional dimension of a second cross-sectional portion of a hair shaft that is acquired from the target area of a patient subsequent in time to the acquisition of the first cross-sectional portion of a hair shaft and to an application of a therapeutic agent to a hair follicle that generated the second cross-sectional hair shaft portion;
determine a difference between the baseline cross-sectional dimension and the post-therapeutic cross-sectional dimension; and
automatically revise a therapeutic regimen frequency, duration, or duty cycle for an application of the therapeutic agent that was applied to the hair follicle that generated the post-therapeutic cross-sectional dimension hair shaft portion as a function of the determined difference between the baseline cross-sectional dimension and the post-therapeutic cross-sectional dimension.
